(19) United States
(12) Patent Application Publication
(10) Pub. No.: US 2023/0231155 A1
(43) Pub. Date: Jul. 20, 2023

(54) RESIN IMPREGNATION OF BIPOLAR PLATES

(71) Applicant: HYDROGENICS CORPORATION, Mississauga (CA)

(72) Inventors: Qing NI, Mississauga (CA); Arun DURAISAMY, Mississauga (CA); Nathaniel JOOS, Toronto (CA)

(21) Appl. No.: 18/149,532

(22) Filed: Jan. 3, 2023

Related U.S. Application Data
(60) Provisional application No. 63/300,503, filed on Jan. 18, 2022.

(51) Int. Cl. H01M 8/0267; H01M 8/0258; H01M 8/0228; H01M 8/04029

(52) U.S. Cl. CPC H01M 8/0267; H01M 8/0258; H01M 8/0228; H01M 8/04029

(57) ABSTRACT

The present disclosure generally relates to systems and methods for impregnating resin in one or more coolant channels in a bipolar plate before or after assembly of the bipolar plates into a fuel cell stack.

### CROSS-REFERENCE TO RELATED APPLICATIONS

This nonprovisional application claims the benefit and priority under 35 U.S.C. § 119(e) and any other applicable laws or statutes, to U.S. Provisional Patent Application Ser. No. 63/300,503 filed on Jan. 18, 2022, the entire disclosure of which is hereby expressly incorporated therein by reference.

### TECHNICAL FIELD

The present disclosure generally relates to methods to reduce leakage in graphite bipolar plates by resin impregnation.

### BACKGROUND

Several fuel cells are assembled into a fuel cell stack and operated to provide power or energy for industrial use. In many mobility applications it is very advantageous to assemble one or more fuel cells or fuel cell stacks to achieve a volumetric power density that better allows for improved vehicle integration.

The fuel cell is a multi-component comprising a membrane electrode assembly (MEA) at the center, a gas diffusion layer (GDL) on both sides of the membrane electrode assembly (MEA), and a bipolar plate (BPP) on the other side of the gas diffusion layer (GDL). The membrane electrode assembly (MEA) is a component that enables electrochemical reactions in the fuel cell.

Reactants supplied to the fuel cell include fuel (e.g., hydrogen, such as pure hydrogen) supplied at an anode and an oxidant (e.g., oxygen) supplied at a cathode. The anode is typically supplied with hydrogen from highly compressed gaseous or liquefied hydrogen stored in onboard tanks. A cooling system including coolant fluids is often configured to be connected with the fuel cell stack to provide a controllable heat sink for excess heat generation during the electrochemical reactions occurring in the fuel cell stack.

Bipolar plates (BPP) in the fuel cell may develop leakage due to porosity or fragility of the material. For example, bipolar plates (BPP) made of graphite or graphite composite) are fragile and may develop cracks during production, transport, and handling. Bipolar plates (BPP) may also develop cracks during joining or assembly of sub-plates (e.g., plates that have not yet been bonded to form bipolar plates (BPP). This is typical if the joining of plates or sub-plates is done by adhesive bonding, and if the bonding material is not leak proof. Leakage can cause unwanted permeation of reactant or coolant. Therefore, it is desirable to reduce permeation as much as possible.

Resin impregnation is a suitable method to render porous material impermeable. The traditional method of resin impregnation has several limitations as it requires large equipment and involves large volumes of chemicals. The vacuum vessel for resin impregnation is usually cylindrical and must be bigger in volume than the sub-plates being impregnated. Use of such large vacuum vessels increases the footprint of a facility, the amount of chemicals consumed, and the waste generated by such a process.

Since the traditional resin impregnation method is employed prior to the formation of bipolar plates, this treatment can only address the pores and micropores in the sub-plate material and not any defects introduced by a downstream processes of bipolar plate (BPP) manufacturing, or transport and handling. Additionally, any subsequent process for bipolar plate manufacturing must be done at a temperature that avoids compromising the effect of resin impregnation. As the resin is applied to all surfaces of the sub-plates, i.e. the anode, cathode, and coolant channels, the resin may increase surface electrical resistance or impact chemical interaction within the MEA or GDL, all of which will affect fuel cell performance.

Accordingly, described herein are methods for resin impregnation of fuel cell bipolar plates (BPP) exclusively through coolant channels.

### SUMMARY

Embodiments of the present disclosure are included to meet these and other needs.

In one aspect, described herein a method of impregnating resin in a bipolar plate comprises creating a vacuum in one or more anode channels, in one or more cathode channels, and in one or more coolant channels in the bipolar plate by opening a first valve and closing a second valve, flowing resin stored in a reservoir through the one or more coolant channels in the bipolar plate by closing the first valve and opening the second valve, draining the resin from the one or more coolant channels by opening the first valve and opening the second valve, flowing air into the one or more coolant channels to further drain the resin, washing the one or more coolant channels by flowing a non-ionic surfactant into them, and impregnating the one or more coolant channels in the bipolar plates with the resin stored in the resin reservoir. The one or more pores in the one or more coolant channels in the bipolar plates are filled with resin.

In some embodiments, the method may comprise creating the vacuum in the one or more anode channels, in the one or more cathode channels, or in the one or more coolant channels in the bipolar plate by a vacuum pump In some embodiments, the method may comprise maintaining the vacuum in the one or more anode channels, in the one or more cathode channels, and in the one or more coolant channels in the bipolar plate for about 1 hour. In some embodiments, the method may comprise introducing pneumatic pressure is into the one or more coolant channels to force the resin to infiltrate into the bipolar plate. In some embodiments, washing the one or more coolant channels by flowing a non-ionic surfactant into the one or more coolant channels may include using a pump to flow the non-ionic surfactant stored in a solution reservoir.

In some embodiments, the method may comprise washing the one or more coolant channels with deionized water. In some embodiments, the method may comprise curing the resin used to fill the one or more pores of the coolant channels in the bipolar plates. In some embodiments, the method may comprise curing the resin used to fill the one or more pores of the coolant channels in the bipolar plates. In some embodiments, curing the resin may comprise utilizing temperature controlled heating of the bipolar plates when the bipolar plates are not assembled into a fuel cell stack. In some embodiments, curing the resin may comprise comprises flowing water at a temperature of about 90° C. to about 100° C. through the one or more coolant channels when the bipolar plates are assembled into a fuel cell stack. In some embodiments, the water may be kept a temperature of about 90° C. to about 100° C. by a heater coil, a water bath, or a heat exchanger.

In some embodiments, the resin used to fill the one or more pores of the coolant channels may be cured without disassembling the bipolar plates that are already assembled into a fuel cell stack. In some embodiments, impregnation of the one or more coolant channels in the bipolar plates with resin may be done without causing any chemical interaction with any other layer of a fuel cell. In some embodiments, the method may be applied after the bipolar plates are manufactured from two sub-plates.

In some embodiments, the one or more pores may be more than about out 100 nm in diameter, and the pores may be sealed with the resin, preventing any leakage of coolant. In some embodiments, the resin may have a viscosity less than about 100 cPs. In some embodiments, the resin may be cured at a temperature less than about 100° C. In some embodiments, the resin may withstand a temperature of about 90° C.

In some embodiments, the method may further include preventing the resin from contaminating a membrane in a fuel cell stack comprising the bipolar plate. In some embodiments, the fuel cell stack may comprise the membrane isolated from a manifold region including a coolant port.

According to a second aspect described herein, a system of impregnating resin into one or more coolant channels in a bipolar plate comprises a resin reservoir, a first valve, and a second valve. The resin reservoir comprises a heat curable and low viscose resin. The first valve is connected to a vacuum pump, wherein the opening of the first valve creates a vacuum in one or more anode channels, one or more cathode channels, and the one or more coolant channels in the bipolar plate. The second valve is connected to the resin reservoir, wherein the opening of the second valve fills the one or more coolant channels in the bipolar plate with the resin.

According to a third aspect described herein, a system of washing resin from one or more coolant channels in a bipolar plate comprises a solution reservoir, a first valve, a second valve, and a pump. The solution reservoir comprises a non-ionic surfactant solution. The first valve is connected to a vacuum pump, wherein opening of the first valve creates a vacuum in one or more anode channels, one or more cathode channels, and the one or more coolant channels in the bipolar plate. The second valve is connected to the solution reservoir, wherein opening of the second valve fills the one or more coolant channels in the bipolar plate with the non-ionic surfactant solution. The pump is connected in between the solution reservoir and the second valve, wherein the pump drives the non-ionic surfactant solution into the one or more coolant channels in the bipolar plate.

In some embodiments, the solution reservoir may comprises deionized water. In some embodiments, the pump may drive the deionized water into the one or more coolant channels in the bipolar plate.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, a hydrogen delivery system, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 illustrates the cross section of a fuel cell stack comprising sub-plates in a bipolar plate;

FIG. 3 illustrates an impregnation system including a vacuum pump, a resin reservoir, and two valves;

FIG. 4 illustrates a rinsing system including a solution reservoir and a pump;

FIG. 5A illustrates the layout of a membrane electrode assembly and sub-gaskets in a fuel cell;

FIG. 5B illustrates the layout of a membrane electrode assembly (MEA) and sub-gaskets that extend to both ends of the MEA;

FIG. 5C illustrates the layout of a membrane electrode assembly (MEA) and sub-gaskets that do not extend to either ends of the MEA; and

FIG. 6 illustrates a fuel cell where the coolant port is isolated from the membrane electrode assembly.

These and other features, aspects, and advantages of the present invention will become better understood when the following detailed description is read with reference to the accompanying drawings described herein. Reference is also made to the accompanying drawings that form a part hereof and in which is shown by way of illustration specific embodiments in which the invention may be practiced. These embodiments are described in sufficient detail to enable those skilled in the art to practice what is claimed and it is to be understood that other embodiments may be utilized and that logical, mechanical, and electrical changes may be made without departing from the spirit and scope of the claims. The following detailed description is, therefore, not to be taken in a limiting sense.

### DETAILED DESCRIPTION

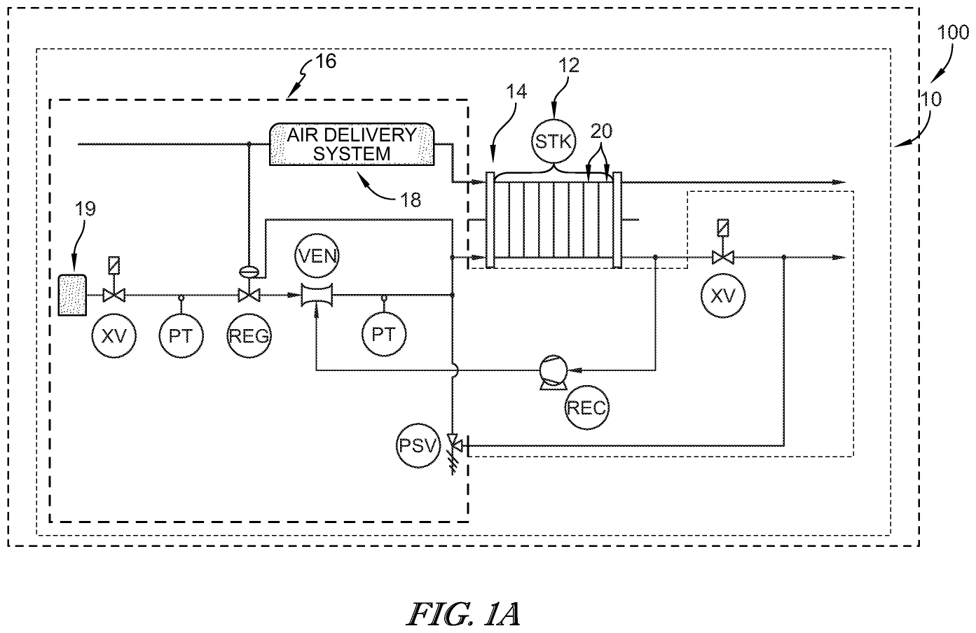

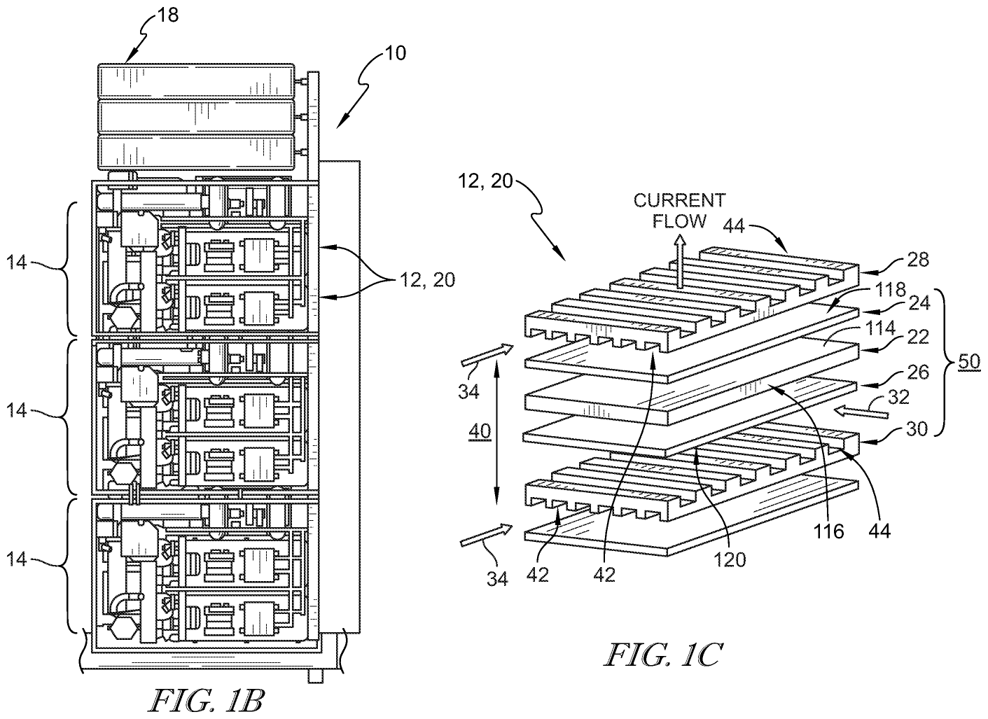

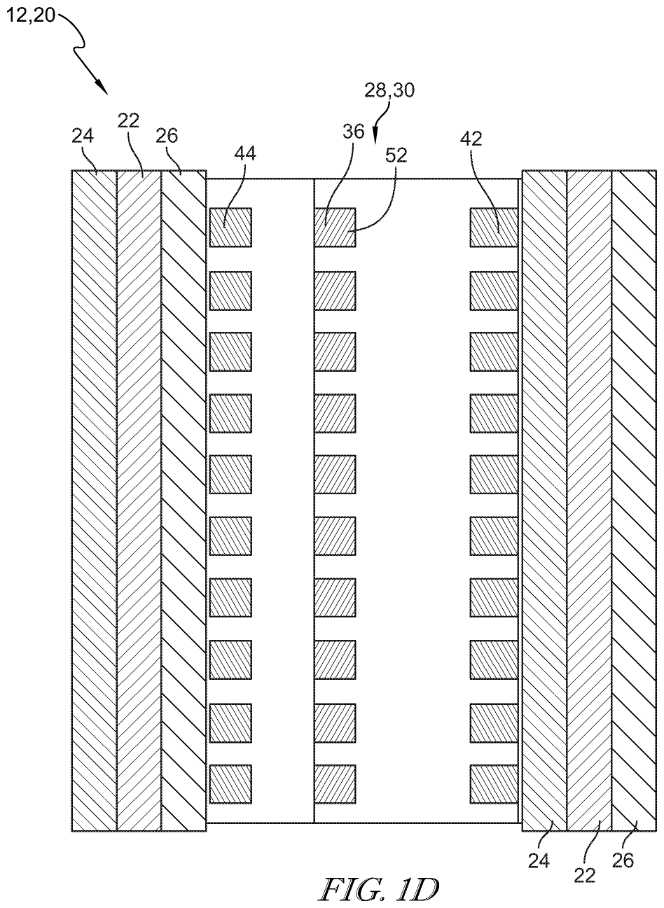

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

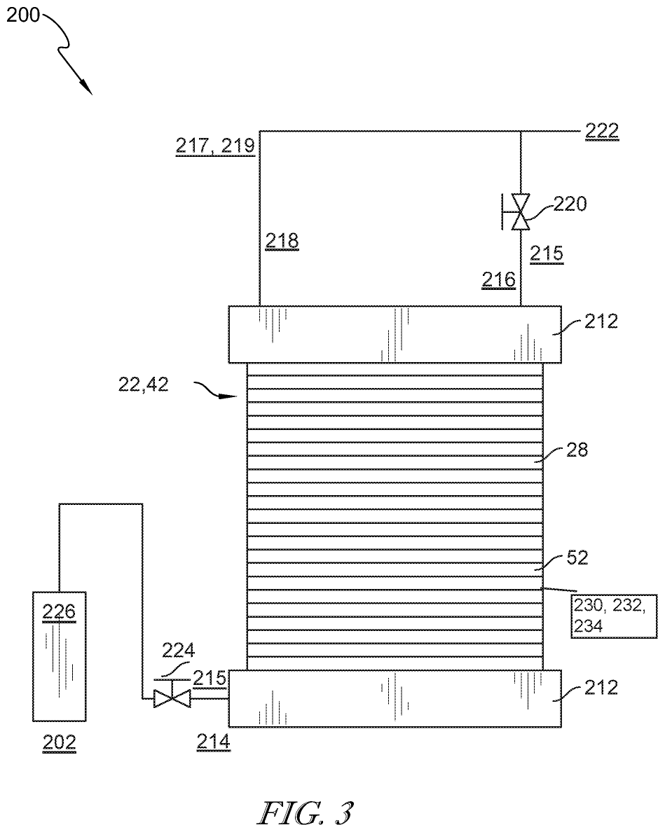

The present disclosure is directed to systems and methods for resin 202 impregnation of fuel cell bipolar plates (BPP) exclusively through coolant channels as shown in FIGS. 3-5. The methods and systems described herein may be used after the bipolar plate (BPP) is assembled from sub-plates or even after the fuel cell stack is fully assembled. Described herein are systems and methods for treating leaks and/or defects caused during the assembly of bipolar plates (BPP) and/or during the assembly of fuel cells or fuel cell stacks.

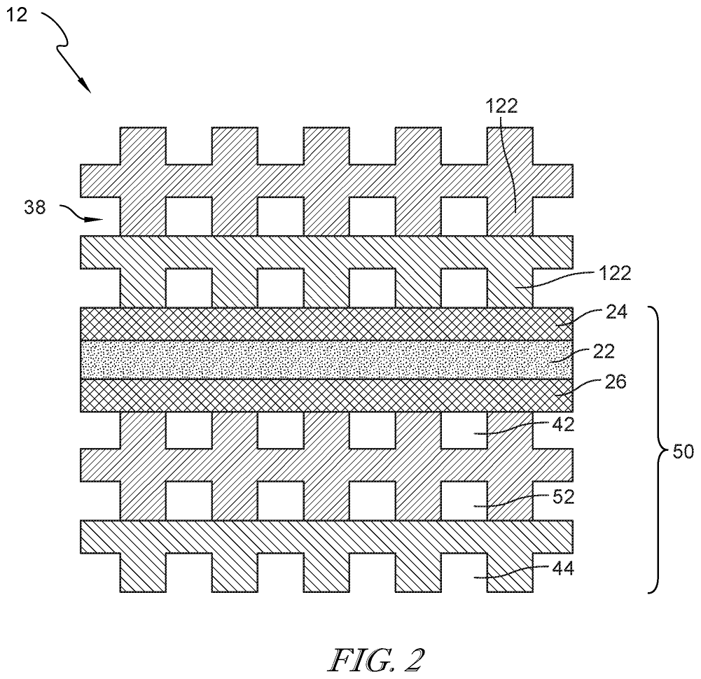

A cross section of a typical repeating unit 50 of the fuel cell stack 12 is shown in FIG. 2. The fuel cell stack 12 typically comprises the membrane-electrode assembly (MEA) 22, gas diffusion layers (GDL) 24, and bipolar plates (BPP) 28. The bipolar plates (BPP) 28, 30 provide channels or flow fields 42, 52, 44 for transporting oxidant 34, coolant 36, and fuel 32 while providing mechanical support and electrical contact in the fuel cell stack 12.

Each bipolar plate (BPP) 28 is produced by the joining of two sub-plates 122, thus forming three the isolated fluid channels or flow fields 42, 52, 44 described previously. The fuel 32 (e.g., hydrogen) flows on one side in the anode or fuel channel or flow field 44, the oxidant 34 (e.g., air) flows on a second side in the cathode or air channels or flow fields 42, and the coolant 36 flows in the volume enclosed by the two sub-plates 122 in the coolant channels or flow fields 52.

The bipolar plates (BPP) 28, 30 or sub-plates 122 may be metal-based plates or carbon-based plates. Carbon-based bipolar plates (BPP) 28, 30 or sub-plates 122, including those made of graphite, graphite-composite, or flexible graphite, offer low cost and longer durability than the bipolar plates (BPP) 28, 30 or sub-plates 122 made of metal. Resin 202 impregnation can be used to treat the sub-plates 122 to fill any pores, micropores, holes, defects, or cracks in them.

Resin 202 impregnation includes the use of a low-viscosity, heat-curable resin 202 to penetrate the voids and cracks in bipolar plates (BPP) 28, 30. However, resin 202 impregnation is mostly applied to individual sub-plates 122. Furthermore, traditional resin 202 impregnation is usually done on flexible graphite plates and not on bipolar plates (BPP) 28, 30 comprising other material.

Traditional resin 202 impregnation includes immersing the sub-plates 122 completely in the resin 202 under vacuum, to allow the resin 202 to penetrate the pores, micropores, holes, defects, and/or cracks in the material. Once the immersion is completed, the sub-plates 122 are rinsed to remove any residual surface resin 202 and heated to allow the resin 202 inside the pores, micropores, holes, defects, or cracks to cure. The resin-impregnated sub-plates 122 are then bonded to produce the bipolar plates (BPP) 28, 30. However, as described previously, this traditional approach presents substantial issues including not correcting for leaks or defects formed during the bonding of the sub-plates 122.

The present disclosure describes a method of resin 202 impregnation that can be used before the bipolar plate (BPP) 28, 30 is assembled from sub-plates 122, after the bipolar plate (BPP) 28, 30 is assembled from sub-plates 122, before the fuel cell stack 12 is fully assembled, and/or after the fuel cell stack 12 is fully assembled. Because the resin 202 is only in contact with the coolant channels 52 of bipolar plate (BPP) 28, 30, there is no anticipated increase of surface electrical resistance or interference of the resin 202 with the core operation of the fuel cell 20 or fuel cell stack 12.

When the method described herein is applied at the end of bipolar plate (BPP) 28, 30 manufacturing, the method allows for treatment of leaks or defects caused during the assembly of bipolar plates (BPP) 28, 30 in preparation of fuel cell stack 12 assembly or during fuel cell stack 12 assembly. The sub-plates 122 may be bonded into bipolar plates (BPP) 28, 30 by any method, including adhesion or welding.

The bipolar plates (BPP) 28, 30 may be assembled into the fuel cell stack 12 by pressure clamping or by using a fastener like bolts, screws, hinges etc. Resin 202 impregnation after the sub-plates 122 are bonded to form bipolar plates (BPP) 28, 30 may correct any bonding leaks or defects formed during the bonding process including but not limited to the above listed methods. The sub-plates 122 subjected to resin 202 impregnation after bipolar plates (BPP) 28, 30 are assembled into the fuel cell stack 12, may or may not have been impregnated with resin 202 before being bonded to form the bipolar plates (BPP) 28, 30.

The method of resin 202 impregnation can be used to treat pores, micropores, holes, defects, and/or cracks that range in size from about 100 nm to about 500 nm, including any specific or range of sizes comprised therein. For example, these pores, micropores, holes, defects, and/or cracks may have a size that ranges from about 200 nm to about 300 nm, from about 300 nm to about 500 nm, including any size comprised therein. In some embodiments, resin 202 impregnation can be used to treat pores, micropores, holes, defects, or cracks larger than about 500 nm or smaller than about 100 nm.

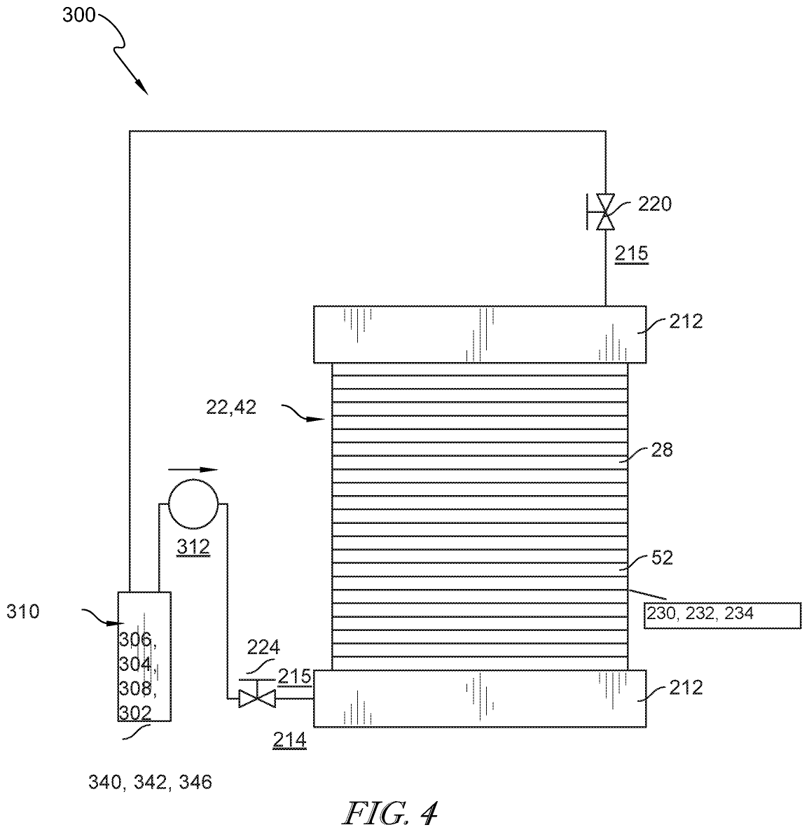

As shown in FIGS. 3-4, the method of resin 202 impregnation of the present disclosure includes passing resin 202 through the coolant channels 52, which does not affect the performance of the fuel cell stack 12 comprising the treated the sub-plates 122 or the bipolar plates (BPP) 28, 30. Such a method seals defects in the coolant channels 52, and thus, prevents leakage of the coolant 36 into the fuel channels 44 and/or into the oxidant channels 42.

The method of resin 202 impregnation before assembly of the bipolar plates (BPP) 28, 30 into the fuel cell stack 12 includes using an impregnation system 200. One embodiment of the impregnation system 200 is shown in FIG. 3. The impregnation system 200 includes a vacuum pump 222, a resin reservoir 226, and valves 224, 220.

One or more bipolar plates (BPP) 28, 30 are clamped between two rigid clamping plates 212. The clamping plates 212 consist of port connections 218, 216, and 214. Anode ports 217 and cathode ports 219 are connected at the port connection 218 to the vacuum pump 222. A coolant port 215 is connected at the port connection 214 to the vacuum pump 222 and at the port connection 216 to the resin reservoir 226.

The resin 202 stored in the resin reservoir 226 is a low viscosity, heat curable resin 202. In one embodiment, the low viscosity of the resin 202 may be about 3 centipoise (cPs). In other embodiments, the low viscosity of resin 202 may range from about 1 cPs to about 100 cPs, including any specific or range of viscosity comprised therein. For example, the low viscosity may range from about 1 cPs to about 20 cPs, about 20 cPs to about 50 cPs, about 50 cPs to about 80 cPs, about 80 cPs to about 100 cPs, or any viscosity or viscosity range comprised therein.

The resin 202 typically comprises a curing temperature depending on its composition. The curing temperature of the resin 202 may be in the range of about 80° C. to about 120° C. including any specific or range of temperature comprised therein. Specifically, the curing temperature of the resin 202 may be in the range of about 80° C. to about 90° C., about 90° C. to about 100° C., about 100° C. to about 110° C., about 110° C. to about 120° C. including any specific or range of temperature comprised therein. For example, the curing temperature may range from about 100° C. to about 120° C., including any temperature or temperature range comprised therein. Typically the curing temperature is about 120° C. or lower. Alternatively, the curing temperature may be about 100° C. or lower. The performance of the fuel cell stack 12 being impregnated with the resin 202 at higher temperatures is negatively impacted.

Furthermore, the resin 202 in the resin reservoir 226 should be able to withstand fuel cell stack 12 operating temperature after curing. The fuel cell stack 12 operating temperature may range from about 85° C. to about 95° C., including any temperature or range of temperature comprised therein. For example, the resin 202 may not disintegrate, break apart, or malfunction at the fuel cell stack 12 operating temperature.

As shown in FIG. 3, the method of resin 202 impregnation includes opening the valve 220 and using the vacuum pump 222 to create a vacuum in the anode and/or fuel channels 44 and in the air and/or cathode channels 42. The impregnation system 200 may be configured to be able to remain under vacuum for an extended period of vacuum time to fully evacuate the air in the pores, micropores, holes, defects, and/or cracks. The extended period of vacuum time may range from about 1 hour to about 3 hours, including any specific or range of time comprised therein. For example the extended period of vacuum time may range from about 2 hours to about 3 hours, including any time or range of time comprised therein.

The method of resin impregnation includes closing the valve 220 and opening the valve 224 to allow the resin 202 from the resin reservoir 226 to fill the entire coolant channels 52 in all the bipolar plates (BPP) 28, 30 in the fuel cell 20 or fuel cell stack 12. In some embodiments, pneumatic pressure may be introduced into the coolant channels 52 to force the resin 202 from the resin reservoir 226 to infiltrate into the bipolar plates (BPP) 28, 30. The pneumatic pressure may be supplied by an air compressor 230 and/or from a compressed gas vessel 232. The pneumatic pressure may depend on the size and configuration of the resin reservoir 226 and/or the size of the bipolar plates (BPP) 28, 30, and may be any specific or range of pressure sufficient to provide force to the resin to effectuate the present method.

The method of resin 202 impregnation includes draining the coolant channels 52 by opening both valves 220 and 224, and introducing an air stream 234 through the coolant channels 52. The air stream 234 will assist the draining of the excess resin 202 from the bipolar plates (BPP) 28, 30. The air stream 234 may be supplied by an air compressor 230 or from a compressed gas vessel 232.

The method of resin 202 impregnation before assembly of the bipolar plates (BPP) 28, 30 into the fuel cell stack 12 includes washing, cleaning, and/or rinsing the interior of the coolant channels 52 of bipolar plates (BPP) 28, 30. A rinsing system 300 is shown in FIG. 4. In the rinsing system 300, the resin reservoir 226 is replaced with a solution reservoir 310 containing a cleaning solution 308. Alternatively, the resin 202 may be replaced with the cleaning solution 308 in the resin reservoir 226. In some embodiments, the resin reservoir 226 may be the same as the solution reservoir 310. In other embodiments, the resin reservoir 226 may be different from the solution reservoir 310.

The cleaning solution 308 may comprise solutions including but not limited to surfactants, non-ionic solutions, and non-ionic surfactants. Preferably, the cleaning solution 308 used to clean the resin 302 may be a non-ionic surfactant. An exemplary non-ionic surfactant cleaning solution 308 used to clean the resin 302 is Triton X-100.

The rinsing system 300 may also include a pump 312. The method of washing, cleaning, and/or rinsing the interior of the coolant channels 52 includes opening the valves 220 and 224 and using the pump 312 to recirculate the cleaning solution 308 through the coolant channels 52 of bipolar plates (BPP) 28, 30. Since both the valves 220 and 224 are open and a vacuum is no longer maintained within the rinsing system 300, the pump 312 is instrumental in circulating the cleaning solution 308 through the coolant channels 52 of bipolar plates (BPP) 28, 30.

The cleaning solution 308 in the solution reservoir 310 can be replaced one or more times until resin 202 is totally washed out of the interior of the coolant channels 52. The cleaning solution 308 may be replaced from about 2 to about 5 times, including any number of times comprised therein. In some embodiments, the cleaning solution 308 may be replaced more than 5 times if all the resin is not washed out of the interior of the coolant channels 52.

The method of washing, cleaning, and/or rinsing the interior of the coolant channels 52 includes replacing the cleaning solution 308 in the solution reservoir 310 with water (e.g., deionized water) 306 to rinse the cleaning solution 308 out of the coolant channels 52. Therefore the method of washing, cleaning, and/or rinsing the interior of the coolant channels 52 further includes rinsing the cleaning solution 308 out of the coolant channels 52 with water (e.g., deionized water) 306. The method of washing, cleaning, and/or rinsing the interior of the coolant channels 52 includes opening the valves 220 and 224 and using the pump 312 for recirculating the deionized water 306 through the coolant channels 52 of bipolar plates (BPP) 28, 30. The deionized water 306 can be replaced multiple times during recirculation. The deionized water 306 may be replaced from about 2 to about 5 times, including any number comprised therein. In some embodiments, the deionized water 306 may be replaced more than 5 times.

The method of resin 202 impregnation before assembly of the bipolar plates (BPP) 28, 30 into the fuel cell stack 12 includes curing the resin in the interior of the coolant channels 52 of bipolar plates (BPP) 28, 30 by applying temperature controlled heat. The method of curing the resin 202 includes removing the bipolar plates (BPP) 28, 30 from the system 200, 300 and heating them in at the curing temperature previously described. The method includes heating the bipolar plates (BPP) 28, 30 at the curing temperature in a controlled manner. For example, the resin 202 may be cured in a temperature controlled oven. The temperature and time to fully cure the resin 202 depends on the chemistry of the resin 202 used for impregnation.

In addition, the time for curing the resin 202 depends on the curing temperature. However, typically, the resin may be cured with a temperature controlled heat or with a temperature controlled oven that ranges from about 80° C. to about 120° C., including any specific or range of temperature comprised therein. In preferred embodiments, the temperature controlled heat or oven does not exceed a maximum temperature of 120° C.

In such temperature controlled environments, the time to cure the resin typically ranges from about 0.5 hours to about 3 hours, including any specific or range of time comprised therein. For example, at a curing temperature of about 100° C., the curing time for the resin 202 is about 1 hour. If the temperature is lowered, then the curing time may need to be extended. Alternatively, the temperature and time to fully cure the resin 202 may be based on recommendations from a resin 202 supplier, based on a differential scan of the resin 202 to determine the range of the curing temperature for the resin 202, and/or based on curing experiments performed (e.g., in real-time) to determine an optimal temperature and time for curing the resin 202.

A method of resin 202 impregnation after assembly of the bipolar plates (BPP) 28, 30 into the fuel cell stack 12 includes using the impregnation system 200 comprising the vacuum pump 222, the resin reservoir 226, and valves 224, 220, as shown in FIG. 3 and as discussed above. The method of resin impregnation after assembly of the bipolar plates (BPP) 28, 30 into the fuel cell stack 12 includes washing the interior of the coolant channels 52 of bipolar plates (BPP) 28, 30 using the rinsing system 300, as shown in FIG. 4 and as discussed above.

This method of curing resin 202 after resin 202 impregnation and assembly of the bipolar plates (BPP) 28, 30 into the fuel cell stack 12 includes curing the resin 202 in the interior of the coolant channels 52 of bipolar plates (BPP) 28, 30 by applying heat without disassembling the fuel cell stack 12. The method of curing resin 202 includes causing heat transfer through the fuel cell stack 12 and protecting the membrane electrode assembly (MEA) 22 of the fuel cell stack 12 from heat damage.

The fuel cell stack 12 comprising the bipolar plates (BPP) 28, 30 is heated by hot water 304 circulation after resin 202 impregnation. The method of curing the bipolar plates (BPP) 28, 30 using hot water 304 circulation includes using the rinsing system 300 as shown in FIG. 4. The cleaning solution 308 in the solution reservoir 310 is replaced with hot water 304 (e.g., hot deionized water). The method includes recirculating the hot water 304 through the coolant channels 52 of bipolar plates (BPP) 28, 30 in the fuel cell stack 12.

The hot water 304 in the solution reservoir 310 is maintained between about 80° C. and about 120° C., including any temperature or range comprised therein. The temperature is maintain by a heater coil 340, a water bath 342, a heat exchanger 344, and/or a different heating mechanism. The hot water 304 is continuously recirculated until the entire fuel cell stack 12 reaches the temperature for the time required to cure the resin 202. The hot water 304 may be recirculated at a flow rate of about 0.5 L/min per plate to about 1 L/min per plate, including any flow rate or range comprised therein. The flow rate of hot water 304 circulation depends on factors including but not limited to the length of the coolant channels 52, the number of bipolar plate (BPP) 28, 30 in the fuel cell stack 12, design of the fuel cell stack 12, and the viscosity of the resin 202 used.

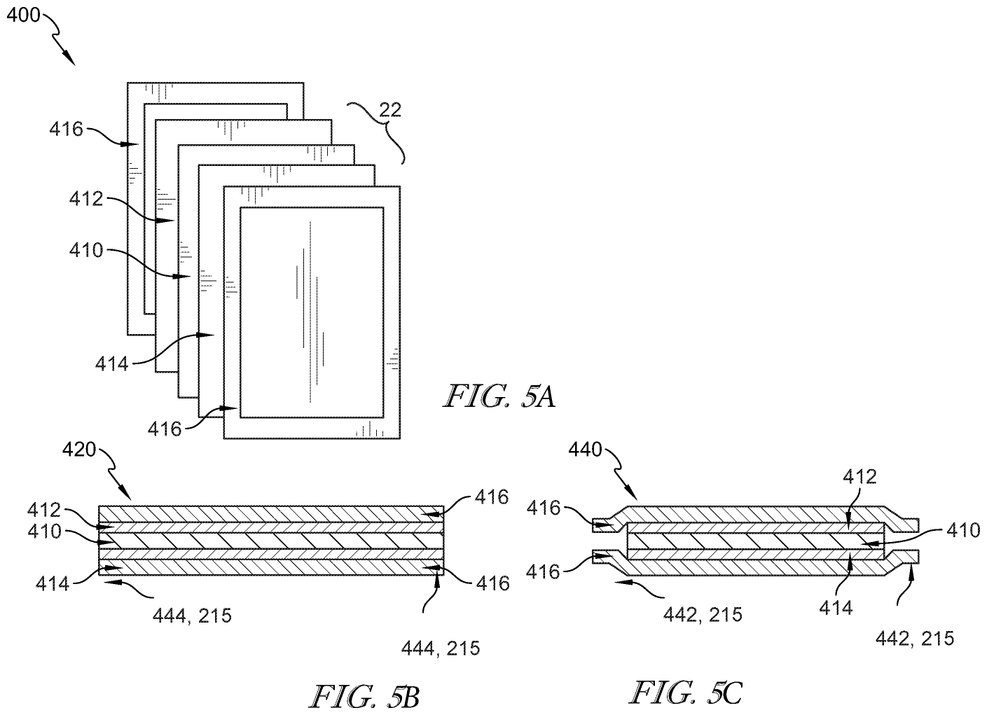

The methods of resin 202 impregnation through the coolant channels 52 described above includes preventing the resin 202 from permeating the MEA 22 of the fuel cell stack 12. As shown in FIG. 5A-5C, the MEA 22 in a fuel cell stack 400, 420, 440 includes a membrane 410, an anode catalyst 412, and a cathode catalyst 414. The MEA 22 is surrounded by sub-gaskets 416 on both sides.

The sub-gaskets 416 may be made of a plastic. Exemplary plastic for the sub-gaskets 416 include polyethylene naphthalate (PEN) or polyethylene terephalate (PET). The lay out of the sub-gasket 416, the anode catalyst 410 the cathode catalyst 414, and the membrane 410 is parallel and extends to the end 444 in a fuel cell stack 420, 440 shown in FIG. 5B-5C.

As shown in FIG. 5C, the MEA 22, including the anode catalyst 410, the cathode catalyst 414, and the membrane 410, does not extend to the ends 442 in the fuel cell stack 440. When the MEA 22 including the anode catalyst 410, the cathode catalyst 414, and the membrane 410 does not extend to the end 442, and the coolant ports are located at the ends 442, the resin 202 may not permeate into the MEA 22 during the impregnation process.

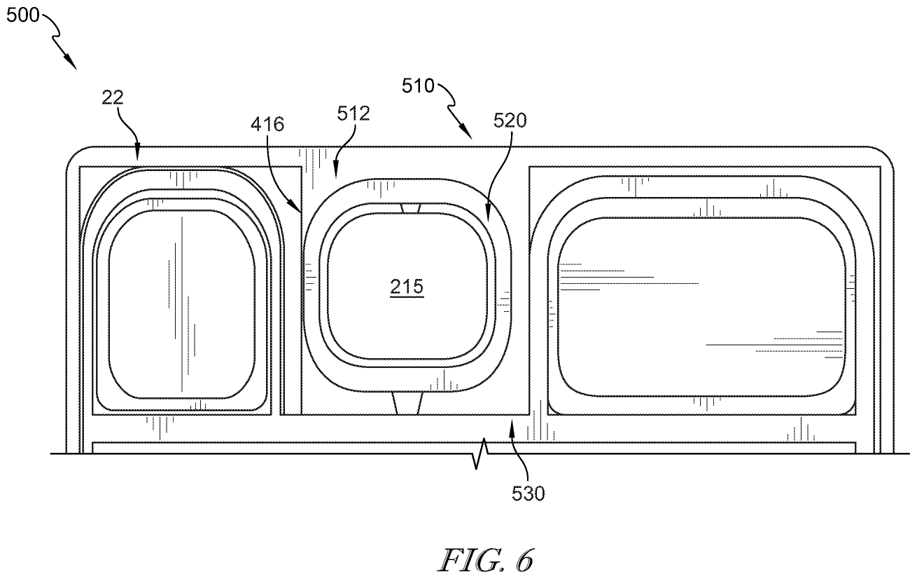

Alternatively, as shown in FIG. 5B, the MEA 22, including the anode catalyst 410, the cathode catalyst 414, and the membrane 410, extends to the ends 444 in the fuel cell stack 420. In such configurations, the resin 202 may not permeate into the MEA 22 during the impregnation process described above since the coolant port 215 in the fuel cell stack 444 is isolated from the MEA 22. The coolant port 215 may be isolated from the MEA 22 either by sealants 520 (as shown in FIG. 6) or by design. If the anode catalyst 410, the cathode catalyst 414, and the membrane 410 extend to the ends 444 in a fuel cell stack 420, the coolant port 215 may be isolated by design from the MEA 22 so that the MEA 22 does not contact the sub-gasket 416 at the location of the coolant port 215.

As shown in FIG. 6, the MEA 22 and the sub-gasket 416 in the fuel cell stack 500 are layered in a ‘H’ shape such that the region of the coolant port 215 does not contact the MEA 22. Additionally, the coolant port 215 has a double sealant design 510 for isolation. The coolant port 215 is separated by a first sealant 520 and a second sealant 530 that isolate the MEA 22 from the manifold region 512.

As a result of this double sealant design, when there is a failure in the structure of coolant port 215, the leakage of the coolant or any resin 202 flowing through the coolant port 215 would result in an external leak yet still not affect the performance of the MEA 22. In other embodiments, the MEA 22 and the sub-gasket 416 may not be layered in a ‘H’ shape, but the MEA 22 may be isolated from the manifold region 512 and the coolant port 215 by a different design.

The method of resin 202 impregnation through the coolant channels 52 described above may include preventing contamination of the MEA 22 by resin 202. The prevention of MEA 22 contamination may include using a fuel cell stack 500 that isolates the MEA 22 from the manifold region 512. Notably, prevention of MEA contamination by the presently described resin impregnation method advantageously extends the life, durability, and overall performance of the fuel cell stack, which ultimately benefits power generation suppliers, consumers, and/or users of fuel cell generated power and electricity.

The following described aspects of the present invention are contemplated and non-limiting:

A first aspect of the present invention relates to a method of impregnating resin in a bipolar plate. The method comprises creating a vacuum in one or more anode channels, in one or more cathode channels, and in one or more coolant channels in the bipolar plate by opening a first valve and closing a second valve, flowing resin stored in a reservoir through the one or more coolant channels in the bipolar plate by closing the first valve and opening the second valve, draining the resin from the one or more coolant channels by opening the first valve and opening the second valve, flowing air into the one or more coolant channels to further drain the resin, washing the one or more coolant channels by flowing a non-ionic surfactant into them, and impregnating the one or more coolant channels in the bipolar plates with the resin stored in the resin reservoir. The one or more pores in the one or more coolant channels in the bipolar plates are filled with resin.

A second aspect of the present invention relates to system of impregnating resin into one or more coolant channels in a bipolar plate. The system comprises a resin reservoir, a first valve, and a second valve. The resin reservoir comprises a heat curable and low viscose resin. The first valve is connected to a vacuum pump, wherein the opening of the first valve creates a vacuum in one or more anode channels, one or more cathode channels, and the one or more coolant channels in the bipolar plate. The second valve is connected to the resin reservoir, wherein the opening of the second valve fills the one or more coolant channels in the bipolar plate with the resin.

A third aspect of the present invention relates to system of washing resin from one or more coolant channels in a bipolar plate. The system comprises a solution reservoir, a first valve, a second valve, and a pump. The solution reservoir comprises a non-ionic surfactant solution. The first valve is connected to a vacuum pump, wherein opening of the first valve creates a vacuum in one or more anode channels, one or more cathode channels, and the one or more coolant channels in the bipolar plate. The second valve is connected to the solution reservoir, wherein opening of the second valve fills the one or more coolant channels in the bipolar plate with the non-ionic surfactant solution. The pump is connected in between the solution reservoir and the second valve, wherein the pump drives the non-ionic surfactant solution into the one or more coolant channels in the bipolar plate. The solution reservoir may comprises deionized water. The pump may drive the deionized water into the one or more coolant channels in the bipolar plate.

In the first aspect of the present invention, the method may comprise creating the vacuum in the one or more anode channels, in the one or more cathode channels, or in the one or more coolant channels in the bipolar plate by a vacuum pump. In the first aspect of the present invention, the method may comprise maintaining the vacuum in the one or more anode channels, in the one or more cathode channels, and in the one or more coolant channels in the bipolar plate for about 1 hour. In the first aspect of the present invention, the method may comprise introducing pneumatic pressure is into the one or more coolant channels to force the resin to infiltrate into the bipolar plate. In the first aspect of the present invention, washing the one or more coolant channels by flowing a non-ionic surfactant into the one or more coolant channels may include using a pump to flow the non-ionic surfactant stored in a solution reservoir.

In the first aspect of the present invention, the method may comprise washing the one or more coolant channels with deionized water. In the first aspect of the present invention, the method may comprise curing the resin used to fill the one or more pores of the coolant channels in the bipolar plates. In the first aspect of the present invention, the method may comprise curing the resin used to fill the one or more pores of the coolant channels in the bipolar plates. In the first aspect of the present invention, curing the resin may comprise utilizing temperature controlled heating of the bipolar plates when the bipolar plates are not assembled into a fuel cell stack. In the first aspect of the present invention, curing the resin may comprise comprises flowing water at a temperature of about 90° C. to about 100° C. through the one or more coolant channels when the bipolar plates are assembled into a fuel cell stack. In the first aspect of the present invention, the water may be kept a temperature of about 90° C. to about 100° C. by a heater coil, a water bath, or a heat exchanger.

In the first aspect of the present invention, the resin used to fill the one or more pores of the coolant channels may be cured without disassembling the bipolar plates that are already assembled into a fuel cell stack. In the first aspect of the present invention, impregnation of the one or more coolant channels in the bipolar plates with resin may be done without causing any chemical interaction with any other layer of a fuel cell. In the first aspect of the present invention, the method may be applied after the bipolar plates are manufactured from two sub-plates.

In the first aspect of the present invention, the one or more pores may be more than about out 100 nm in diameter, and the pores may be sealed with the resin, preventing any leakage of coolant. In the first aspect of the present invention, the resin may have a viscosity less than about 100 cPs. In the first aspect of the present invention, the resin may be cured at a temperature less than about 100° C. In the first aspect of the present invention, the resin may withstand a temperature of about 90° C.

In the first aspect of the present invention, the method may further include preventing the resin from contaminating a membrane in a fuel cell stack comprising the bipolar plate. In the first aspect of the present invention, the fuel cell stack may comprise the membrane isolated from a manifold region including a coolant port.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first”, “second”, “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising”, “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method of impregnating resin in a bipolar plate comprising:
creating a vacuum in one or more anode channels, in one or more cathode channels, and in one or more coolant channels in the bipolar plate by opening a first valve and closing a second valve,
flowing resin stored in a reservoir through the one or more coolant channels in the bipolar plate by closing the first valve and opening the second valve,
draining the resin from the one or more coolant channels by opening the first valve and opening the second valve,
flowing air into the one or more coolant channels to further drain the resin,
washing the one or more coolant channels by flowing a non-ionic surfactant into them,
impregnating the one or more coolant channels in the bipolar plates with the resin stored in the resin reservoir,
wherein one or more pores in the one or more coolant channels in the bipolar plates are filled with resin.

2. The method of claim 1, wherein the vacuum in the one or more anode channels, in the one or more cathode channels, or in the one or more coolant channels in the bipolar plate is created by a vacuum pump.

3. The method of claim 1, wherein the vacuum in the one or more anode channels, in the one or more cathode channels, and in the one or more coolant channels in the bipolar plate is maintained for about 1 hour.

4. The method of claim 1, wherein pneumatic pressure is introduced into the one or more coolant channels to force the resin to infiltrate into the bipolar plate.

5. The method of claim 1, wherein washing the one or more coolant channels by flowing a non-ionic surfactant into the one or more coolant channels include using a pump to flow the non-ionic surfactant stored in a solution reservoir.

6. The method of claim 1, wherein the method further comprises washing the one or more coolant channels with deionized water.

7. The method of claim 6, wherein the method further comprises curing the resin used to fill the one or more pores of the coolant channels in the bipolar plates.

8. The method of claim 7, wherein curing the resin comprises temperature controlled heating of the bipolar plates when the bipolar plates are not assembled into a fuel cell stack.

9. The method of claim 7, wherein curing the resin comprises flowing water at a temperature of about 90° C. to about 100° C. through the one or more coolant channels when the bipolar plates are assembled into a fuel cell stack.

10. The method of claim 9, wherein the water is kept a temperature of about 90° C. to about 100° C. by a heater coil, a water bath, or a heat exchanger.

11. The method of claim 1, wherein the resin used to fill the one or more pores of the coolant channels is cured without disassembling the bipolar plates that are already assembled into a fuel cell stack.

12. The method of claim 1, wherein impregnation of the one or more coolant channels in the bipolar plates with resin is done without causing any chemical interaction with any other layer of a fuel cell.

13. The method of claim 1, wherein the method is applied after the bipolar plates are manufactured from two sub-plates.

14. The method of claim 1, wherein the resin has a viscosity less than about 100 cPs.

15. The method of claim 1, wherein the resin can be cured at a temperature less than about 100° C.

16. The method of claim 1, wherein the resin can withstand a temperature of about 90° C.

17. The method of claim 1, wherein the method includes preventing the resin from contaminating a membrane in a fuel cell stack comprising the bipolar plate.

18. The method of claim 17, wherein the fuel cell stack comprises the membrane isolated from a manifold region including a coolant port.

19. A system of impregnating resin into one or more coolant channels in a bipolar plate comprising:
a resin reservoir containing a heat curable and low viscose resin,
a first valve connected to a vacuum pump, wherein the opening of the first valve creates a vacuum in one or more anode channels, one or more cathode channels, and the one or more coolant channels in the bipolar plate, and
a second valve connected to the resin reservoir, wherein the opening of the second valve fills the one or more coolant channels in the bipolar plate with the resin.

20. A system of washing resin from one or more coolant channels in a bipolar plate comprising:
a solution reservoir containing a non-ionic surfactant solution,
a first valve connected to a vacuum pump, wherein opening of the first valve creates a vacuum in one or more anode channels, one or more cathode channels, and the one or more coolant channels in the bipolar plate,
a second valve connected to the solution reservoir, wherein opening of the second valve fills the one or more coolant channels in the bipolar plate with the non-ionic surfactant solution, and
a pump connected in between the solution reservoir and the second valve, wherein the pump drives the non-ionic surfactant solution into the one or more coolant channels in the bipolar plate.
